(19) United States
(12) Patent Application Publication
(10) Pub. No.: US 2013/0050690 A1
(43) Pub. Date: Feb. 28, 2013

(54) CALIBRATION DEVICE FOR LIGHT MEASURING EQUIPMENT

(71) Applicants: Sang Yong YU, Gyeonggi-do (KR); Eun Hee Bong, Gyeonggi-do (KR); Seok Kim, Gyeonggi-do (KR); Sun Kyong Kim, Gyeonggi-do (KR); Jae Youn Jeong, Gyeonggi-do (KR)

(72) Inventors: Sang Yong YU, Gyeonggi-do (KR); Eun Hee Bong, Gyeonggi-do (KR); Seok Kim, Gyeonggi-do (KR); Sun Kyong Kim, Gyeonggi-do (KR); Jae Youn Jeong, Gyeonggi-do (KR)

(73) Assignee: SAMSUNG ELECTRO-MECHANICS CO., LTD.

(21) Appl. No.: 13/566,537

(22) Filed: Aug. 3, 2012

(30) Foreign Application Priority Data
Aug. 24, 2011 (KR) 10-2011-0084631

(51) Int. Cl. G01J 1/10

(52) U.S. Cl. 356/243.1

(57) ABSTRACT

Disclosed herein is a calibration device for a light measuring equipment, the calibration device including: a standard illuminant emitting light for calibration; and a universal jig fixing target light measuring equipments to be calibrated having various sizes and moving in a direction in parallel with an optical axis of the standard illuminant. Therefore, it is possible to use both of a method of performing calibration by changing a distance between the standard illuminant and the target light measuring equipment to be calibrated and a method of performing calibration by changing a current applied to the standard illuminant. In addition, it is possible to perform calibration for the light measuring equipment having a plurality of sensors and to significantly improve accuracy of calibration.

### CROSS REFERENCE(S) TO RELATED APPLICATIONS

This application claims the benefit under 35 U.S.C. Section 119 of Korean Patent Application Serial No. 10-2011-0084631, entitled “Calibration Device for Light Measuring Equipment” filed on Aug. 24, 2011, which is hereby incorporated by reference in its entirety into this application.

### BACKGROUND OF THE INVENTION

1. Technical Field

The present invention relates to a calibration device, and more particularly, to a calibration device for a light measuring equipment capable of calibrating various light measuring equipments such as an illumination measuring equipment, a light distribution measuring equipment, and the like.

2. Description of the Related Art

As a method of calibrating a light measuring equipment, a method of comparing a value measured by a target light measuring equipment to be calibrated with an energy value of a standard illuminant using a verified standard illuminant has been generally used.

The method of calibrating a light measuring equipment as described above may be largely divided into two methods. As a first method, there is a method of using increase/decrease effect in light energy according to a distance between a standard illuminant, which is a light energy source, and a target light measuring equipment to be calibrated while fixing a position of the standard illuminant and changing a position of the target light measuring equipment to be calibrated. This method may flexibly cope with a case in which conditions of a calibration device change or an illuminant higher than a standard illuminant is used; however, it has a disadvantage in that an absolute standard value may continuously change.

As a second method, there is a method of obtaining a standard value by precisely controlling a current applied to a standard illuminant. This method has an advantage in that calibration may be performed in a state in which all of the hardware of a light system are fixed without movement; however, it has a disadvantage in that a current value applied to a standard illuminant may change according to the circumstances such as conditions of a ramp, or the like.

Further, since the calibration method according to the related art as described above should use a jig appropriate for each light measuring equipment, it may not cope with a case in which a kind or a shape of light measuring equipment changes or a light measuring equipment has a plurality of sensors.

### SUMMARY OF THE INVENTION

An object of the present invention is to provide a calibration device for a light measuring equipment capable of using both of a method of performing calibration by changing a distance between a standard illuminant and a target light measuring equipment to be calibrated and a method of performing calibration by changing a current applied to a standard illuminant, regardless of a size and a shape of the target light measuring equipment to be calibrated, a form of a sensor, or the like.

According to an exemplary embodiment of the present invention, there is provided a calibration device for a light measuring equipment, the calibration device including: a standard illuminant emitting light for calibration; and a universal jig fixing target light measuring equipments to be calibrated having various sizes and moving in a direction in parallel with an optical axis of the standard illuminant.

The universal jig may include: a left-right support part moving in a left-right direction and supporting a side of the target light measuring equipment to be calibrated; and an up-down support part moving in an up-down direction and supporting a lower surface of the target light measuring equipment to be calibrated.

The calibration device may further include a protective film closing a space between the standard illuminant and the universal jig.

The calibration device may further include a diffused reflection blocking film installed to be adjacent to the target light measuring equipment to be calibrated and having an opening part formed therein, the opening part having the light for calibration penetrating therethrough, wherein the opening part includes an edge part formed on an inner peripheral surface thereof, the edge part sharply protruding toward the center of the opening part.

The calibration device may further include a laser generator generating a laser beam for arranging an optical axis in order to align the standard illuminant and the target light measuring equipment to be calibrated with each other.

The calibration device may further include an iris adjusting a spreading angle and energy density of the laser beam for arranging an optical axis.

### BRIEF DESCRIPTION OF THE DRAWINGS

FIG. 1 is a perspective view showing a calibration device for a light measuring equipment according to an exemplary embodiment of the present invention;

FIG. 2 is a perspective view showing a universal jig shown in FIG. 1;

FIG. 3 is a perspective view showing a diffused reflection blocking film shown in FIG. 1; and

FIG. 4 is a cross-sectional view taken along line I-I′ of FIG. 3.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

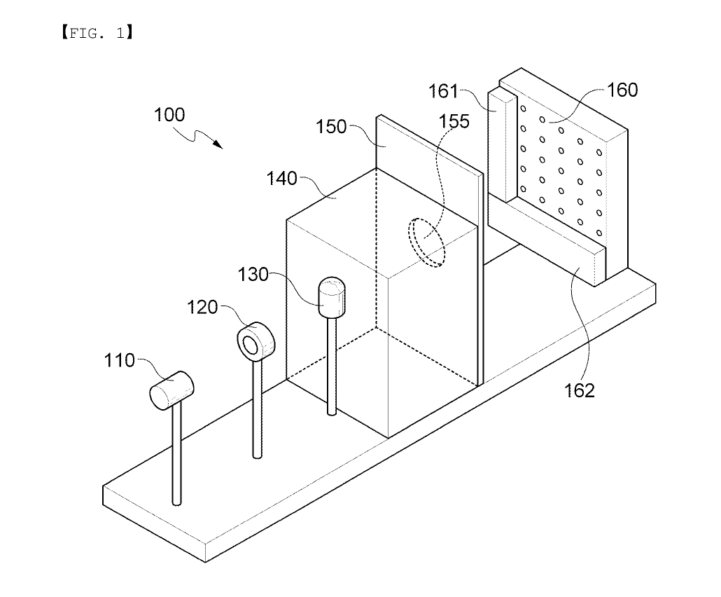

FIG. 1 is a perspective view showing a calibration device for a light measuring equipment according to an exemplary embodiment of the present invention. Referring to FIG. 1, a calibration device 100 for a light measuring equipment according to an exemplary embodiment of the present invention includes a standard illuminant 130 and a universal jig 160.

As the standard illuminant 130, which is a device emitting light energy for calibration, a previously verified illuminant is used. In addition, the universal jig 160 may fix target light measuring equipments to be calibrated having various sizes and shapes and is installed to be movable in a direction in parallel with an optical axis of the standard illuminant 130.

That is, since the universal jig 160 may move in a direction in which it is close to or distant from the standard illuminant 130, the target light measuring equipment to be calibrated may be calibrated by a method of using increase/decrease effect in light energy according to a distance between the light measuring equipment fixed to the universal jig 160 and the standard illuminant 130.

In addition, a method of calibrating the light measuring equipment by precisely controlling a current value applied to the standard illuminant 130 in a state in which a constant distance between the standard illuminant 130 and the target light measuring equipment to be calibrated is maintained without moving the universal jig 160 may also be used.

As described above, the calibration device 100 for a light measuring equipment according to the exemplary embodiment of the present invention may use both of the method of performing calibration by changing the distance between the standard illuminant 130 and the target light measuring equipment to be calibrated and the method of performing calibration by changing the current applied to the standard illuminant 130.

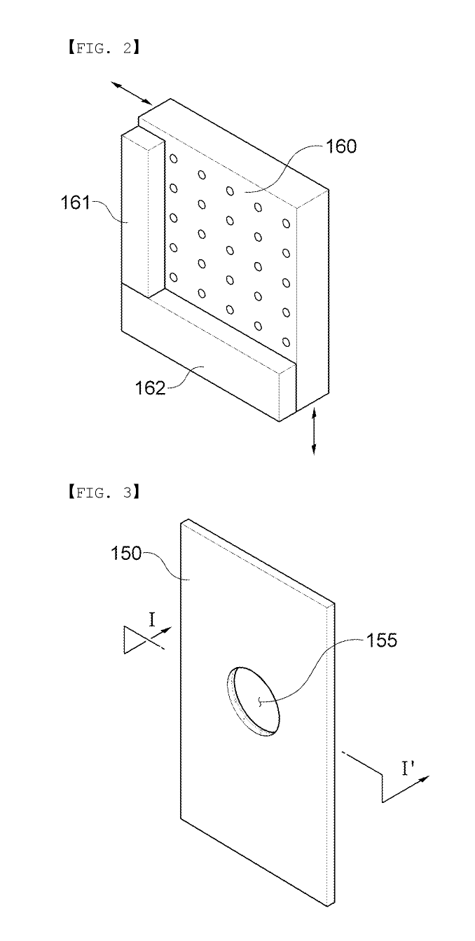

FIG. 2 is a perspective view showing the universal jig 160. Referring to FIG. 2, the universal jig 160 includes a left-right support part 161 and an up-down support part 162.

The left-right support part 161 is moveable in a left-right direction and supports a side of the target light measuring equipment to be calibrated. In addition, the up-down support 162 is moveable in an up-down direction and supports a lower surface of the target light measuring equipment to be calibrated.

As described above, the universal jig 160 uses the support parts of which positions may change, thereby making it possible to fix the light measuring equipments having various sizes and shapes and to precisely move a position of the fixed light measuring equipment in a direction perpendicular to the optical axis of the standard illuminant 130.

Therefore, in the case of the light measuring equipment having a plurality of sensors, since each sensor may move the light measuring equipment to a position at which light energy of the standard illuminant 130 may be received, the light measuring equipment having the plurality of sensors may also be calibrated.

In addition, the universal jig 160 may also be configured to further include an operating member such as a motor, or the like, thereby automatically controlling a change in a distance between the universal jig 160 and the standard illuminant 130, a change in a position of the target light measuring equipment to be calibrated, or the like.

Meanwhile, the calibration device 100 for a light measuring equipment according to the exemplary embodiment of the present invention may further include a protective film 140 closing a space between the standard illuminant 130 and the universal jig 160.

This protective film 140 serves to reduce a temperature change generated due to contact between the light energy emitted from the standard illuminant 130 and the external atmosphere, thereby improving accuracy of light energy for calibration. In addition, the protective film 140 may prevent spill light from the outside from being mixed with the light energy for calibration.

Further, the calibration device 100 for a light measuring equipment according to the exemplary embodiment of the present invention may further include a diffused reflection blocking film 150 installed to be adjacent to the target light measuring equipment to be calibrated and having an opening part 155 formed therein, wherein the opening part 155 has the light for calibration penetrating therethrough.

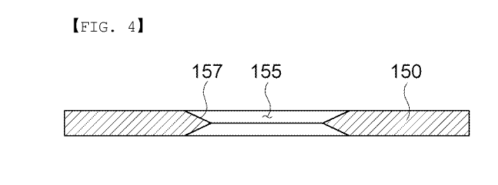

FIG. 3 is a perspective view showing the diffused reflection blocking film 150 shown in FIG. 1; and FIG. 4 is a cross-sectional view taken along line I-I′ of FIG. 3. Referring to FIGS. 3 and 4, the opening part 155 formed in the diffused reflection blocking film 150 may include an edge part 157 formed on an inner peripheral surface thereof, wherein the edge part 157 sharply protrudes toward the center of the opening part 155.

Diffused reflection generated in the inner peripheral surface of the opening part 155 is suppressed through the edge part 157, thereby making it possible to suppress scattering of light energy for calibration arriving at the target light measuring equipment to be calibrated. Therefore, it is possible to further improve accuracy of light energy for calibration arriving at the light measuring equipment.

Meanwhile, the calibration device 100 for a light measuring equipment according to the exemplary embodiment of the present invention may further include a laser generator 110 generating a laser beam for arranging an optical axis in order to align the standard illuminant 130 and the target light measuring equipment to be calibrated with each other. The laser beam is used for arranging the standard illuminant 130 and the target light measuring equipment to be calibrated with each other, thereby making it possible to more precisely align the standard illuminant 130 and the target light measuring equipment to be calibrated with each other.

Further, the calibration device 100 for a light measuring equipment according to the exemplary embodiment of the present invention may further include an iris 120 installed to be adjacent to the laser generator 110. The iris 120 adjusts a spreading angle and energy density of the laser beam for arranging an optical axis, thereby making it possible to further improve alignment precision between the standard illuminant 130 and the target light measuring equipment to be calibrated.

With the calibration device for a light measuring equipment according to the exemplary embodiment of the present invention, it is possible to use both of a method of performing calibration by changing a distance between the standard illuminant and the target light measuring equipment to be calibrated and a method of performing calibration by changing a current applied to the standard illuminant.

In addition, it is possible to perform calibration for the light measuring equipment having a plurality of sensors and to significantly improve accuracy of calibration.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. A calibration device for a light measuring equipment, the calibration device comprising:
a standard illuminant emitting light for calibration; and
a universal jig fixing target light measuring equipments to be calibrated having various sizes and moving in a direction in parallel with an optical axis of the standard illuminant.

2. The calibration device according to claim 1, wherein the universal jig includes:
a left-right support part moving in a left-right direction and supporting a side of the target light measuring equipment to be calibrated; and
an up-down support part moving in an up-down direction and supporting a lower surface of the target light measuring equipment to be calibrated.

3. The calibration device according to claim 1, further comprising a protective film closing a space between the standard illuminant and the universal jig.

4. The calibration device according to claim 1, further comprising a diffused reflection blocking film installed to be adjacent to the target light measuring equipment to be calibrated and having an opening part formed therein, the opening part having the light for calibration penetrating therethrough,
wherein the opening part includes an edge part formed on an inner peripheral surface thereof, the edge part sharply protruding toward the center of the opening part.

5. The calibration device according to any one of claims 1 to 4, further comprising a laser generator generating a laser beam for arranging an optical axis in order to align the standard illuminant and the target light measuring equipment to be calibrated with each other.

6. The calibration device according to claim 5, further comprising an iris adjusting a spreading angle and energy density of the laser beam for arranging an optical axis.
